(19) United States
(12) Patent Application Publication
(10) Pub. No.: US 2026/0122361 A1
(43) Pub. Date: Apr. 30, 2026

(54) MULTI-APERTURE DEVICE AND ASSOCIATED METHODS

(71) Applicant: FRAUNHOFER-GESELLSCHAFT ZUR FOERDERUNG DER ANGEWANDTEN FORSCHUNG E.V., Muenchen (DE)

(72) Inventors: Christoph Freitag, Jena (DE); Alexander Oberdoerster, Jena (DE); Christoph Munkelt, Jena (DE)

(21) Appl. No.: 19/371,701

(22) Filed: Oct. 28, 2025

(30) Foreign Application Priority Data
Oct. 29, 2024 (DE) 10 2024 210 401.9

(51) Int. Cl. H04N 23/958; G03B 5/00; H04N 23/951

(52) U.S. Cl. CPC H04N 23/958; G03B 5/00; H04N 23/951; G03B 2205/0046

(57) ABSTRACT

A multi-aperture device includes an arrangement of at least two optical channels, wherein each optical channel includes optics for imaging a field of view. A first optical channel is configured to image the field of view with a first locally varying magnification. A second optical channel is configured to image the field of view with a second locally varying magnification. The arrangement of optical channels is configured to image at least a partial area of the field of view through the first optical channel and through the second optical channel with different local magnifications.

### CROSS-REFERENCE TO RELATED APPLICATIONS

This application claims priority from German Patent Application No. 10 2024 210 401.9, which was filed on Oct. 29, 2024, and is incorporated herein in its entirety by reference.

The present invention relates to a multi-aperture device for imaging a field of view with locally different magnifications in optically different channels. The present invention further relates to corresponding methods and, in particular, to compact, multiscale imaging by means of a camera array or by means of at least two optical channels/cameras.

### BACKGROUND OF THE INVENTION

Multi-aperture devices can image the object field or field of view using several partial fields of view. In some concepts, the use of a beam-deflecting system, such as a mirror, enables a viewing direction of the camera channels to be deflected from the device plane in a different direction of the overall system, for example approximately perpendicular to the same. In the case of a mobile phone, for example, this perpendicular direction may be in the direction of the user's face or in the direction of the surroundings in front of the user and may essentially be achieved by means of switchable folding mirrors.

Some multi-aperture devices segment the total field of view in order to merge the individual images obtained into an overall image.

The overall length of a camera, i.e. the extension along its optical axis, is generally at least as long as the focal length of its objective, although exceptions may apply for alternative optical designs that are only technically feasible in special cases. In a digital camera, the focal length for a desired field of view (FOV) is determined by the number of pixels and their size. The pixel size in turn is limited by technical aspects such as crosstalk, semiconductor production or similar, and by physical boundary conditions such as light diffraction or the quantisation of light.

With reference to FIG. 12, this effect is illustrated for an image height I. The parameter ΔΘ describes the angle above the projection centre of the channel that is spanned by a pixel at the optical axis. The focal length of a camera f_{eff} is given by the number of pixels n, the pixel size Δd and the field of view α and can be expressed as

$${f}_{eff} = \frac{n \cdot Δ p}{2 \cdot tan \frac{α}{2}}$$

In certain applications, however, a flat camera is desirable, for example because the installation space along the optical axis is limited. These may be special industrial applications or use in cars, for example in interior cameras that are installed in the roof lining. Another relevant application is in the field of mobile phones or smartphones. Here, the camera is possibly and clearly the thickest component.

To address the problem of size, it is possible, among other things, to accept compromises in the number of pixels. The number of pixels automatically reduces the possible effective focal length and thus the overall height of the camera. In recent years, however, the quality of the camera has become an increasingly important differentiating criterion for various applications, including smartphones.

The following approaches for reducing the overall height of higher-quality cameras that do not want to compromise on the number of pixels are known:

In one concept, two or more optical channels are interlaced, each with a lower resolution, which is also referred to as Multi-Image Super Resolution, see [1]. This approach is based on the fact that the channels together achieve a higher resolution than a single channel. This is only the case under certain boundary conditions. To summarise, it is needed that the resolution of the objectives is higher than that of the sensors and that the fill factor of the pixels on the sensors is significantly less than 1. The channels have to be registered with sub-pixel accuracy, taking parallax and distortion into account. These boundary conditions are rarely fulfilled in practice, see [2] and [3]. The sufficiently precise and cost-effective production of the channels is also problematic. Approaches with wafer-level optic, where this tends to be more feasible, as described in [4], again do not achieve the overall resolution that would be needed for applications in smartphones. Finally, the integration of optomechanics such as focus and image stabilisation in this concept is another challenge that has not yet been solved.

In other concepts, the camera is installed horizontally in order to deflect the beam path by 90° with a mirror. Now the height of the system, i.e. the extension perpendicular to the optical axis, is the relevant dimension to be minimised. This in turn is determined by the image height I and an aperture diameter A, which is not shown. The camera is therefore flatter when I and A are smaller than f_{eff}, see FIG. 12. This is the case for cameras with a comparatively small field of view, such as telephoto cameras. This approach is therefore used for the telephoto camera or zoom camera of smartphones.

In a further concept, it is taken into account that the field of view (smallest dimension, i.e. vertical) is typically approx. 45° for the normal focal length and therefore I is approximately equal to f_{eff}. However, if the image is cut in half, the height of the camera is halved, limited by the aperture diameter A. At the same time, the field of view is also halved; however, if a copy of the camera is added as a second optical channel, this can cover the missing half of the field of view. If the second channel is installed skillfully, this does not increase the height of the overall system, see [5].

However, combining the partial images into an error-free overall image is not trivial. This is mainly due to the fact that the two optical channels are necessarily juxtaposed to each other. The channels therefore capture a scene from slightly different viewpoints. This fact leads to a parallax, i.e. an apparent displacement of objects depending on their distance from the camera.

This effect has to be corrected to ensure that the partial images are merged without interference. This is made more difficult by the fact that the structure of the scene and the distance to objects is not known, which means that the size of the parallax is also initially unknown.

An approach to solving this problem is to estimate the parallax by doubling each of the two channels into a stereo pair. There are now two channels for the first, possibly upper, and two for the other, possibly lower, half of the picture. Each image area is observed from two different viewpoints, allowing the distance to be triangulated.

However, this solution also doubles the volume, weight and cost of the overall system. There are also occlusion effects that can lead to errors in the depth map at object edges and to gaps in the parallax-corrected image, as shown in FIG. 13. Image errors 1002₁-1002₄ occurring for different images 1000₁-1000₄ are shown there. In other words, FIG. 13 shows different error patterns that can occur by filling gaps during parallax correction.

Finally, the aforementioned solution does not take into account the fact that several cameras with different fields of view are built into current smartphones. This is particularly serious, as it would need the aforementioned increase in volume for each of the cameras.

A multi-aperture device and corresponding methods that enable efficient image generation with a small size would be desirable.

### SUMMARY

According to an embodiment, a multi-aperture device may have: an arrangement of at least two optical channels, wherein each optical channel includes optics for imaging a field of view; wherein a first optical channel is configured to image the field of view with a first locally varying magnification; wherein a second optical channel is configured to image the field of view with a second locally varying magnification; wherein the arrangement of optical channels is configured to image at least a partial area of the field of view through the first optical channel and through the second optical channel with mutually different local magnifications.

According to another embodiment, a method for generating an overall image may have the steps of: normalising a first multiscale image of a field of view to obtain a first normalised image; and normalising a second multiscale image of the field of view to obtain a second normalised image; determining a plurality of corresponding points in the first normalised image and the second normalised image; determining corresponding pixels in the first and second normalised images; wherein a weight is assigned to each pixel; using the corresponding pixel for the overall image to which the greatest weight is assigned.

According to another embodiment, a method for detecting a field of view may have the steps of: imaging the field of view with a first locally varying magnification with a first optical channel; imaging the field of view with a second locally varying magnification with a second optical channel; so that at least a partial area of the field of view is imaged through the first optical channel and through the second optical channel with different local magnifications.

According to another embodiment, a method for manufacturing a multi-aperture device may have the steps of: arranging at least two optical channels so that each optical channel includes optics for imaging a field of view; so that a first optical channel is configured to image the field of view with a first locally varying magnification; so that a second optical channel is configured to image the field of view with a second locally varying magnification; so that the arrangement of optical channels images at least a partial area of the field of view through the first optical channel and through the second optical channel with different local magnifications.

One finding of the present invention is that by using multiscale images in such a way that different parts of the field of view are scanned with different local magnifications, a high level of image information can be obtained with a small size and low-error image generation is possible. Multiscale images can be understood as images with varying local magnifications, which can be used in the context of the embodiments in such a way that the same partial areas are magnified differently from one another in different optical channels.

According to an embodiment, a multi-aperture device includes an arrangement of at least two optical channels, wherein each optical channel includes optics for imaging a field of view. A first optical channel is configured to image the field of view with a first locally varying magnification and a second optical channel is configured to image the field of view with a second locally varying magnification. The arrangement of optical channels is configured to image at least a partial area of the field of view through the first optical channel and through the second optical channel with different local magnifications.

According to an embodiment, the first optical channel is arranged to provide a first multiscale image of the field of view and the second optical channel is arranged to provide a second multiscale image of the field of view. Providing a multiscale image in one optical channel makes it possible to avoid multiple acquisitions with different resolutions, which minimises the number of sources of error.

According to an embodiment, the first locally varying magnification is different with respect to the second locally varying magnification, but possibly related to each other. The magnification is unequal in the different images in relation to a matching area of the field of view or image area. This makes it possible to improve low-resolution local image information with higher-resolution image information from the other channel.

According to an embodiment, a first image effected with the first optical channel has a decreasing magnification starting from a magnification maximum. A second image effected with the second optical channel has a decreasing magnification starting from a magnification maximum. In accordance with the principle of foveated imaging, this makes it possible to achieve areas of high information density in terms of magnification or resolution, which is advantageous for subsequent combination.

According to an embodiment, the multi-aperture device is arranged for catadioptric imaging with a first optical channel and for catadioptric imaging with the second optical channel. This makes it possible to implement the advantageous information compression in the structure of the optical channels, which is low-cost and advantageous for the subsequent calculation.

According to an embodiment, the first optical channel comprises a first beam-deflecting element with a first beam-deflecting surface for deflecting a first beam path of the first optical channel. The first beam-deflecting surface comprises a first surface curvature in order to at least partially effect the first locally varying magnification. Alternatively or additionally, the second optical channel comprises a second beam-deflecting element with a second beam-deflecting surface for deflecting a second beam path of the second optical channel. The second beam-deflecting surface comprises a surface curvature in order to at least partially effect the second locally varying magnification. Surface curvatures can be produced simply yet precisely and at the same time can enable functional integration of the advantageous embodiments in such beam-deflecting elements.

According to an embodiment, the first surface curvature comprises a spatially or locally variable and in particular increasing or decreasing curvature starting from an optical axis of the first optical channel. This may include a monotonic or even strictly monotonic increase or decrease. Alternatively or additionally, the second surface curvature may have a spatially or locally variable curvature starting from an optical axis of the second optical channel. It is advantageous that in an implementation in which both surface curvatures are variable, both are formed in the same increasing or decreasing manner. This enables a high degree of homogeneity of the image content in the images obtained.

According to an embodiment, the first beam-deflecting surface and the second beam-deflecting surface each have a substantially planar area which is arranged for a first magnification of a partial field of view of the field of view detected based on the planar area. Furthermore, the first beam-deflecting surface has a curved area arranged adjacent to the planar area, which is arranged for a lower second magnification of a partial field of view of the field of view detected based on the curved area. The essentially planar area may therefore be curved with a low curvature, up to a value of zero, i.e. planar, and the adjacent area may be more curved in contrast. This enables particularly favourable production and manufacturing.

According to an embodiment, based on the varying magnification, a first image of the field of view obtained with the first optical channel has a first magnification for a first partial area of the field of view and a comparatively lower second magnification for a second partial area of the field of view. Furthermore, based on the varying magnification, a second image of the field of view obtained with the second optical channel has a third magnification for a third partial area of the field of view and a comparatively lower fourth magnification for a fourth partial area of the field of view. The first partial area and the fourth partial area overlap at least partially and/or the second partial area and the third partial area overlap at least partially. This means that areas of high and low resolution overlap.

According to an embodiment, the first beam-deflecting surface and/or the second beam-deflecting surface have a local convex area. A compression obtained with the convex area is localised in different channels in at least partially corresponding areas of the total field of view. Alternatively, the first beam-deflecting surface and/or the second beam-deflecting surface have a local concave area, wherein a compression obtained with the concave area is localised in different channels in at least partially corresponding areas of the field of view. This also enables a high imaging quality to be achieved.

According to an embodiment, the first surface curvature runs along two orthogonal directions and/or the second surface curvature runs along two orthogonal directions. This means that foveated imaging may be implemented easily and precisely in the multi-aperture device.

According to an embodiment, the multi-aperture device is configured to magnify areas at the edge of the field of view in the first optical channel and in the second optical channel to a lesser extent than areas in the centre of the field of view. Despite the overlapping of the image information, this enables a reproduction of human ways of viewing, in which areas in the centre receive more attention than those at the edges.

According to an embodiment, the multi-aperture device includes an actuator means for adjusting a focus of the multi-aperture device and/or for performing optical image stabilisation. This enables a further improvement in imaging quality.

According to an embodiment, the implementation of the local variation of the magnification is at least partially provided in the optics. For this purpose, first optics of the first optical channel is configured to at least partially effect the locally varying magnification and/or second optics of the second optical channel is configured to at least partially effect the locally varying magnification. This makes it possible to implement local magnification even without beam-deflecting means or with plane mirrors or by shifting the complexity from the beam-deflecting means to the optics.

According to an embodiment, the first locally varying magnification is formed to be continuously variable along at least one image direction of the first optical channel and/or the second locally varying magnification is formed to be continuously variable along at least one image direction of the second optical channel. This enables a high imaging quality by avoiding discontinuities.

According to an embodiment, the multi-aperture device comprises at least a third optical channel, wherein each area of the field of view is detected by at least two optical channels. This enables the image information content to be increased.

According to an embodiment, the third optical channel is configured to provide at least one image with a substantially uniform magnification across the optical channel. This enables low-error image information merging.

According to an embodiment, the third optical channel is arranged between the first optical channel and the second optical channel in the arrangement, which enables symmetrical effects in terms of the parallax, which is advantageous.

According to an embodiment, the multi-aperture device includes image sensor means, wherein each optical channel is arranged for imaging the field of view on an image sensor area of the image sensor means. This enables efficient quality control of the imaging quality at an early stage.

According to an embodiment, the multi-aperture device includes image processing means configured to obtain first image information from a first image sensor area associated with the first optical channel and to obtain second image information from a second image sensor area associated with the second optical channel and to combine the first image information and the second image information into an overall image. This enables convenient output of the combined image information or the overall image.

According to an embodiment, the multi-aperture device is configured to utilise image information associated with the optical channels as reference image information, for example but not necessarily as a primary channel, and to determine corresponding points in image information of at least one other channel with respect to the reference image information. The overall image may be created for at least a subset of corresponding points based on the image information that provides the image information with the greatest magnification or resolution for the corresponding point. This may possibly, but not necessarily, include information about the pixels.

According to an embodiment, the image processing means is configured to calculate the overall image as a continuously rectified image with uniform magnification and a field of view dependent on the magnification. This enables the combined functionality of the multi-aperture device analogue to several camera types, for example telephoto cameras, normal cameras and/or wide-angle cameras.

According to an embodiment, a method for generating an overall image is provided. The method includes normalising a first multiscale image of a field of view to obtain a first normalised image and normalising a second multiscale image of a field of view to obtain a second normalised image. The method includes determining a plurality of corresponding points in the first normalised image and the second normalised image and determining corresponding pixels in the first and second normalised images. Each pixel is assigned a weight. The method involves using the corresponding pixel for the overall image to which the greatest weight is assigned.

According to an embodiment, a method for detecting a field of view includes imaging the field of view with a first locally varying magnification with a first optical channel and imaging the field of view with a second locally varying magnification with a second optical channel, so that at least a partial area of the field of view is imaged by the first optical channel and by the second optical channel with different local magnifications from one another.

A method for manufacturing a multi-aperture device includes arranging at least two optical channels so that each optical channel includes optics for imaging a field of view. The method is performed such that a first optical channel is configured to image the field of view with a first locally varying magnification and a second optical channel is configured to image the field of view with a second locally varying magnification. The method is further implemented in such a way that the arrangement of optical channels images at least a partial area of the field of view through the first optical channel and through the second optical channel with different local magnifications.

### BRIEF DESCRIPTION OF THE DRAWINGS

Embodiments of the present invention will be detailed subsequently referring to the appended drawings, in which:

FIG. 1 is a schematic representation of a multi-aperture device according to an embodiment;

FIG. 2 is a schematic block diagram illustrating a principle according to the invention using a scene or field of view as an example;

FIG. 3A is a schematic representation of a field of view according to an embodiment, to which an exemplary 2× digital zoom 34 is applied;

FIG. 3B is a schematic representation of the sensor surface from FIG. 3A with the 2× digital zoom compared with a multiscale image according to embodiments;

FIG. 4 is a schematic block diagram of a multi-aperture device according to an embodiment, in which the multi-aperture device includes a camera;

FIG. 5 is a schematic perspective view of a multi-aperture device according to an embodiment, in which optical channels are arranged juxtaposed;

FIG. 6 is a schematic representation of magnification curves on a sensor plane according to embodiments;

FIG. 7 is a schematic front view of parts of a multi-aperture device according to an embodiment, in which at least a third optical channel is provided;

FIG. 8A-8C are exemplary configurations for the arrangement of optical channels according to embodiments;

FIG. 9 is a schematic flow diagram of a method according to an embodiment, by means of which an overall image can be generated;

FIG. 10 is a schematic flow diagram of a method according to an embodiment, which can be used, for example, to detect a field of view;

FIG. 11 is a schematic flow diagram of a method for providing a multi-aperture device according to an embodiment;

FIG. 12 is a geometric representation of a known effect for linking the optical parameters focal length, image height and viewing angle; and

FIG. 13 are exemplary error images that can result from filling gaps during the parallax correction.

### DETAILED DESCRIPTION OF THE INVENTION

Before embodiments of the present invention are explained in more detail below with reference to the drawings, it is pointed out that identical, functionally identical or equal elements, objects and/or structures are provided with the same reference signs in the different figures, so that the description of these elements shown in different embodiments is interchangeable or can be applied to one another.

The following embodiments are described in connection with a large number of details. However, embodiments may also be implemented without these detailed features. Furthermore, for the sake of clarity, embodiments are described using block diagrams as a substitute for a detailed illustration. Furthermore, details and/or features of individual embodiments can be combined with one another, as long as it is not explicitly described to the contrary.

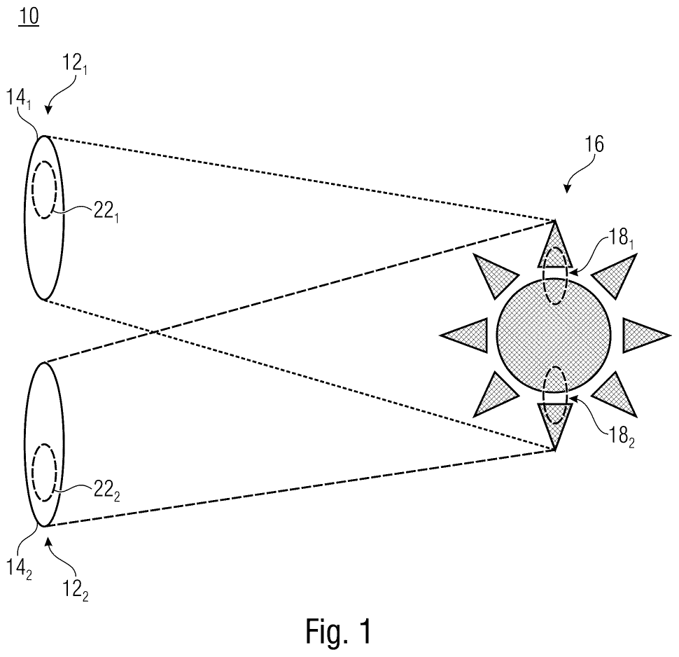

FIG. 1 shows a schematic representation of a multi-aperture device 10 according to an embodiment. The multi-aperture device includes at least two optical channels 12₁ and 12₂, wherein each optical channel 12₁ and 12₂ includes optics 14₁ and 14₂, respectively, for imaging a field of view 16. The optics 14₁ and 14₂ can be formed with a single optical element, for example a lens, in each case and independently of one another, but also in correspondence with the other optics, but combinations of optical elements, for example one or more lenses, aperture structures, false light-suppressing structures and the like can also be arranged. For example, several optical elements, such as lenses, may be arranged in a common lens barrel or the like. Each of the optical elements may, for example, be made of glass material or a polymer material and have a round, polygonal or other type of geometry, such as a free-form surface or the like. Alternatively or additionally, each of the optics 14₁ and/or 14₂ may include diffractive elements or adaptive elements, such as liquid lenses or the like.

The optical channels 12₁ and 12₂ are arranged and aligned in such a way that a substantially corresponding area of a scene is captured as simultaneously as possible. This means that the field of view 16 is essentially the same, i.e. within a tolerance range of 10%, 5% or 2%, advantageously less, so that image content captured with the optical channel 12₁ and image content captured with the optical channel 12₂ are the same, apart from geometric effects such as the parallax.

The optical channel 12₁ is configured to image the field of view 16 with a first locally varying magnification. The locally varying magnification may be realised between a minimum magnification value and a maximum magnification value, possibly using one or more local minima and/or maxima. A factor between the largest magnification and the smallest magnification may, for example, have a value of at least 2, at least 3, at least 5, at least 10 or more, such as at least 13, and in this respect clearly distinguishes itself from production-related fluctuations, which are generally kept low or should be avoided. As a result, for example, an area 18₁ of the field of view 16 is imaged with a magnification that is different from other areas of the optical channel 12₁, for example a higher or lower magnification. This is shown as an example in an area of changed magnification 22₁. The optical channel 12₂ is configured to image the field of view 16 with a second locally varying magnification. For example, an area 18₂ of the field of view 16 is imaged with a different magnification compared to other areas, for example an increased or decreased magnification. This is also shown in an area 22₂.

The areas 18₁ and 18₂ may be disjoint or overlap incompletely. It is advantageous that the areas 18₁ and 18₂ differ at least in parts. It is conceivable, but less advantageous, that the areas 18₁ and 18₂ are imaged with a discrete value of a different magnification compared to the other areas, as this can result in undesirable artefacts. It is therefore advantageous that a transition between different magnification values in the optical channels 12₁ and 12₂ takes place continuously, which is why a plurality or multitude of different magnification values may be implemented in the optical channels 12₁ and 12₂.

The field of view 16 may be captured at different magnifications at different points of an overall optic. For example, the optics 14₁ and/or 14₂ may be arranged for this purpose. For example, the optics 14₁ may be configured to at least partially effect the locally varying magnification and/or the optics 14₂ may be configured to at least partially effect the locally varying magnification of the optical channel 14₂.

In the context of the embodiments discussed herein, an optic, which can also be referred to as an objective, is understood to be an arrangement with at least one imaging element, such as a lens element, and may also be described as an objective. An optional beam-deflecting element, such as a mirror, is separate from this, even if a localised compression or magnification change is carried out with a beam-deflecting surface. The beam-deflecting element is nevertheless part of the optical channel.

This may be achieved by a combination of lens elements and/or lens shapes or the like. Alternatively or additionally, however, the locally varying magnification may also be effected in whole or in part and in the same or different ways for the optical channels in an optional beam-deflecting element and/or in an optional image sensor element. This means that if additional beam-deflecting means are arranged, which are optional for the multi-aperture device 10, the locally varying magnification may also be implemented there in whole or in part. Alternatively or additionally, if an optional image sensor arrangement is arranged for the multi-aperture device 10, the implementation of the locally varying magnification may also be used there in whole or in part.

The arrangement of the optical channels 12₁ and 12₂ is configured to image at least a partial area of the field of view through the optical channel 12₁ and through the optical channel 12₂ with different local magnifications. This is the case, for example, for the area in which the fields of view of the optical channels 12₁ and 12₂ overlap. If the area 18₁ is viewed alternatively or additionally, it is imaged in different resolutions in the optical channels 12₁ and 12₂; this also applies to the area 18₂ and also to any other partial area or section of the field of view 16 which includes at least one of the areas 18₁ and/or 18₂ in whole or in part. It should be noted that, in the context of the embodiments, there are areas in 18 that are magnified differently in different optical channels, but that this does not preclude the existence of other areas where the magnification curves and/or the magnification of different optical channels may be the same.

The locally varying magnification or one-dimensional change may be carried out along one or both image directions of a two-dimensional image. While the one-dimensional implementation already enables simple merging of image information, a two-dimensional implementation makes it possible to realise effects in accordance with foveated imaging. Embodiments enrich the principle of splitting the field of view across multiple channels in a camera array with a concept that overcomes both of the challenges described above. On the one hand, it is avoided that parts of the total field of view are only depicted by one channel at a time. Instead, within the tolerance range mentioned, all areas of the total field of view are imaged with varying magnification but in all channels. Low-resolution areas in one channel may be supplemented or combined with the same high-resolution section of the total field of view from another channel. The locally lower resolution of one channel may be used, for example, to transfer the high-resolution version of the other part with a different perspective. On the other hand, the demanding requirements of some applications, such as smartphones, can be met by using telephoto to wide-angle objectives to depict different viewing angles. A global, radial or two-dimensional variation of the magnification, i.e. a two-dimensional implementation, in the sense of foveated imaging may be transferred, superimposed or additionally arranged on the previously mentioned local variation of the magnification, i.e. the locally varying magnification, for example as a one-dimensional change or change along one direction, which can also be described as continuously multiscale imaging.

This may be achieved, for example, by the first surface curvature extending along two orthogonal directions and/or the second surface curvature extending along two orthogonal directions. As an embodiment of this, this makes it possible to magnify areas at the edge of the field of view less than areas in the centre of the field of view or the optical channel.

Although this may initially result in distortion in the images, it is possible to reconstruct high-resolution rectified images with infinitely variable magnification within a range. Images with high magnification, comparable to the image of a telephoto objective, only cover a central section of the total field of view after reconstruction, while reconstructed images with reduced magnification may extend further to the edges of the total field of view. The resolution of these reconstructed images corresponds to a part of the resolution that covers the total field of view. A corresponding method is described, for example, using method 900.

Overall, the solutions described here combine several advantages. The height of the cameras may be turned in a non-critical direction according to the already demonstrated principle of the camera array if, for example, beam-deflecting elements are used, which opens up new areas of compact, high-intensity optical imaging. The previous challenges due to the parallaxes of the various channels are addressed with the embodiments described here by redundancy of the imaging of the field of view without necessarily doubling the number of channels. Furthermore, multiscale imaging enables the reconstruction of high-resolution images equivalent to continuous telephoto to wide-angle images, possibly but not necessarily in smartphones, from a single parallel image measurement in all channels.

The multi-aperture device 10 may, for example, be implemented without optional beam-deflecting means and/or without an optional image sensor. Thus, the implementation without an image sensor makes it possible to create a device for installation in an overall system with an image sensor, i.e. to equip an image sensor provided elsewhere with the advantages described herein.

In the following, two concepts are presented and described separately in accordance with the embodiments described herein for solving the parallax problem and continuously multiscale imaging, and then merged in a third subsection.

### Continuously Multiscale Imaging

Embodiments relate to multiscale imaging along one or more image directions. The magnification or resolution may be changed in discrete steps, but is done continuously to avoid artefacts.

The field of foveated imaging deals, among other things, with image measurements that have a resolution that decreases radially from a fixed point. The progression of the resolution or magnification may have discrete steps or be continuous. The image sensor itself may have a decreasing pixel density from the centre or the optical imaging may generate a radially increasing compression of the field of view. This means that the locally varying magnification may be implemented either fully or partially in the image sensor or fully or partially in the optical imaging, wherein the optical imaging includes the lenses and the optional beam-deflecting means.

In both cases, raw images can be created which, based on equalisation or decompression, have the highest or highest resolution around the fixed point and a lower or lowest resolution at the edge.

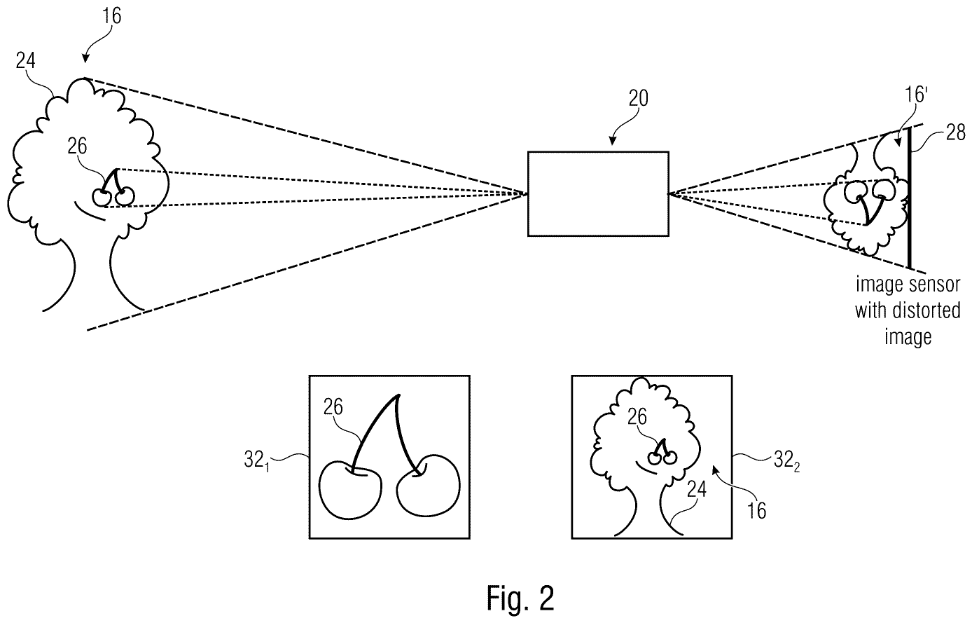

FIG. 2 shows a schematic block diagram to illustrate such a principle using a scene or a field of view 16 as an example, in which both a tree 24 and a detail thereof, for example cherries 26, e.g. on a branch, are imaged on an image sensor of a multiscale imaging optics 20 according to an embodiment. In this example, the optics is configured to provide the radially dependent compression of the total field of view, i.e. the locally varying magnification, advantageously along both image directions. For example, the fixed point is placed on detail 26, the cherries, which are imaged at high magnification on the sensor plane. The entire tree 24 itself may also be imaged, but with a magnification decreasing to the edge. To this end, FIG. 2 shows an example of an image sensor 28 and an image 16′ generated by means of the imaging optics 20, which can be imaged onto the image sensor 28. It should be noted that the image sensor 28 may also be part of a device implemented with the imaging optics 20, a multi-aperture imaging device or multi-aperture device.

FIG. 2 also shows images 32₁ and 32₂, which can be calculated from the image 16′ using the configurations described herein, once an image 32₁ with the detail 26 at high magnification and once an image 32₂, in which the field of view 16 is possibly completely depicted on a possibly comparable image size.

In other words, FIG. 2 shows a representation of a scene that is imaged on the sensor 28 using foveated imaging or multiscale imaging in a distorted manner such that there is a continuous transition from a high magnification at the fixed point to a low magnification at the edge. The fixed point of the foveated image may deviate from a main point that describes the point of penetration of the optical axis on the sensor. The images 32₁ and 32₂ are used to depict rectified images with high magnification, which are constructed with the highest resolution from the central area of the distorted raw image, here for example the cherries in the tree. High-resolution, rectified images with low magnification may be given a larger viewing angle up to the overall view, here the tree in image 32₂.

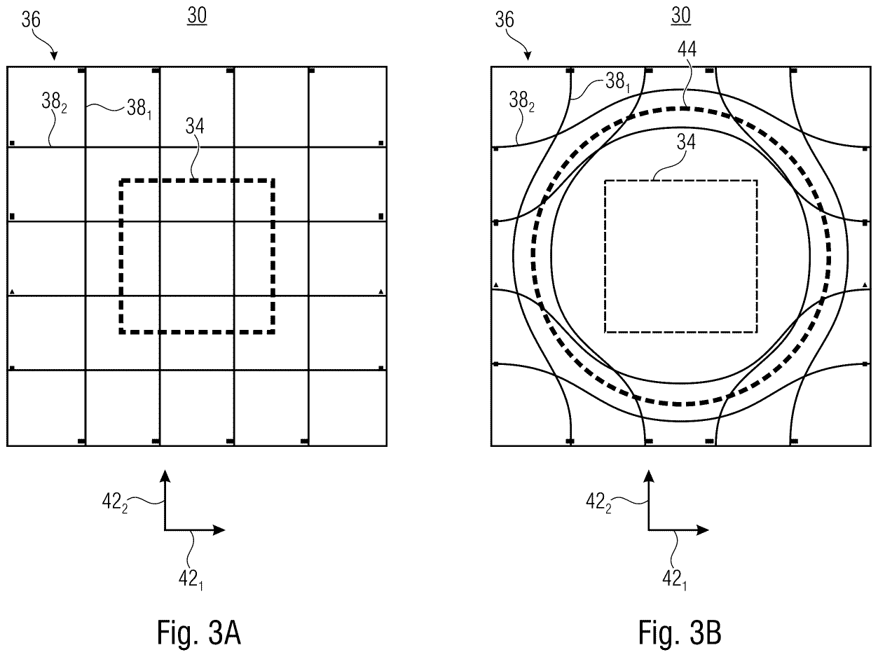

From a distorted, continuously multiscale raw image, continuously rectified images with constant magnification and a field of view that depends on the magnification can be reconstructed. In contrast to the digital zoom in familiar cameras, the resolution does not necessarily decrease proportionally when zooming into a continuously multiscale raw image. For example, if considering a well-known pinhole camera image on a 40 megapixel (Mpx) sensor, a traditional digital zoom reconstructs an image at 2× magnification with an effective resolution of 10 Mpx=40 Mpx/2². In contrast, continuously multiscale imaging expands the central area of the field of view at the expense of the periphery, which is compressed, as shown in FIGS. 3A and 3B. As a result, the same partial area of the field of view that was selected in the digital zoom example spans more than 10 Mpx in the continuously multiscale image. If the total field of view is to be reconstructed in an equalised form, embodiments provide for the central area to be compressed again by interpolation or similar. As a result, a rectified image that spans the entire field of view does not contain the full 40 Mpx of the sensor, but a lower resolution. Depending on the degree of distortion, the resolution can be handled or varied between the different continuous magnifications; for example, if the focus is placed on high resolution in telephoto ranges, wide-angle reconstructions may lose resolution and vice versa.

With reference to FIG. 3A, a field of view 30 is shown to which an exemplary 2× digital zoom 34 is applied. A portion of the 2× digital zoom 34 in a total sensor area 36 is therefore, for example, ¼ (½²).

FIG. 3B shows the sensor surface 36 with the 2× digital zoom 34 from FIG. 3A. When using a multiscale image according to embodiments, it becomes clear on the one hand that gradients or auxiliary lines 38₁ and 38₂ are curved along a respective image direction 42₁ and 42₂ compared to FIG. 3A and that an image area 44 of a multiscale image is enlarged compared to the 2× digital zoom 34, which is why an image of comparatively high quality can be obtained there.

In other words, FIGS. 3A and 3B show the same field of view 30 twice, in FIG. 3A with a pinhole camera, in FIG. 3B with a continuously multiscale optic. A double digital zoom (dotted square 34 in FIG. 3A) is imaged on a larger sensor area (dotted area 44 in FIG. 3B) and thus with a higher resolution in continuously multiscale imaging. For comparison, FIG. 3B shows the area 34 covered by the double digital zoom with a dashed line.

A possible implementation for continuously multiscale imaging is the use of a combination of a conventional camera with objective and a curved mirror with the same magnification ratios as described above. Like the camera array variants presented so far, such an implementation can be categorised in the technical field of catadioptric imaging. This refers to the use of a combination of lenses and mirrors in an imaging system. The curvature of the mirror has a lower curvature closer to the optical axis than further away from the optical axis, resulting in a magnification that decreases away from the optical axis. An inverse implementation or an implementation deviating from this is easily possible.

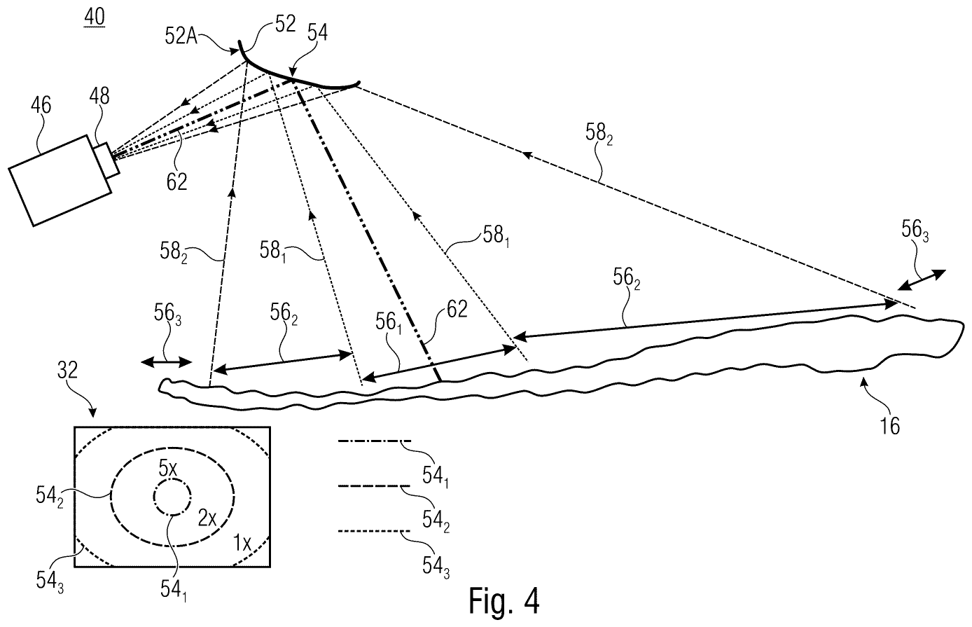

FIG. 4 shows a schematic block diagram of a multi-aperture device 40 according to an embodiment. The multi-aperture device 40 may include a camera 46 with multi-scale optics 48 used for at least two optical channels. However, this is optional here, as beam-deflecting means 52 may already provide a multiscale characteristic of the image. The camera 46 may include image sensor means in which an image sensor area is provided for imaging for each of the optical channels.

The beam-deflecting means 52 is configured to deflect a beam path of the optical channels from the field of view 16 to the camera 46. With a curvature of a specular or reflective or beam-deflecting surface 52A that increases outwards from a centre 54, it can be achieved that different areas are enlarged differently in the captured image 32, as shown by means of isolines 54ᵢ with i=1, 2, 3. The isolines 54; are associated with a constant magnification and can be transferred to areas 56; of the field of view 16.

In other words, FIG. 4 shows a possible implementation of a continuously multiscale image using a curved mirror. Visual rays 58₁ close to an optical axis 62 near the optical channel shown hit an almost planar part of the mirror 52 and largely maintain their angle to the optical axis. In contrast, the larger angles of the visual rays 58₂ to the optical axis are reduced by reflection at points further out on the mirror. FIG. 32 shows a representation of the magnification falling radially from the centre of the imaging plane in the form of isolines.

According to embodiments, a multi-aperture device is provided in which the first locally varying magnification is formed to be continuously variable along at least one image direction of the first optical channel and/or in which the second locally varying magnification is formed to be continuously variable along at least one image direction of the second optical channel. Although gradual changes are also possible, this involves a great deal of effort when correcting the image and is therefore less favourable. With reference to FIG. 4, it is pointed out that the local variation of the magnification, for example using the curved mirror along one or both image directions, may be used.

An individual beam-deflecting element may be assigned to each of the optical channels, wherein these can be part of a one-piece element or a common structure or may also be implemented individually. According to an embodiment, it is provided that the first optical channel of the multi-aperture device has a first beam-deflecting element with a first beam-deflecting surface 52A for deflecting a first beam path of the first optical channel. The first beam-deflecting surface 52A has a first surface curvature in order to at least partially effect the first locally varying magnification of the channel. Alternatively or additionally, this is also provided for the second optical channel, so that a second beam-deflecting element with a second beam-deflecting surface 52A for deflecting a second beam path of the second optical channel is assigned to it. The second beam-deflecting surface has a second surface curvature in order to at least partially effect the second locally varying magnification. If both channels are equipped with a corresponding beam-deflecting element, the curvatures in the channels may be formed equally or unequally to each other. Unequal implementations can be understood as the degree of curvature, the gradient of curvature as well as the location of the maximum and/or minimum magnification in the field of view.

In an embodiment, surface curvatures of the first and/or second optical channel or the optics or lenses are configured such that an increasing curvature of the surface 52A is provided starting from an optical axis of the respective optical channel. Alternatively, a decreasing curvature starting from the optical axis may be implemented in at least one of the optical channels.

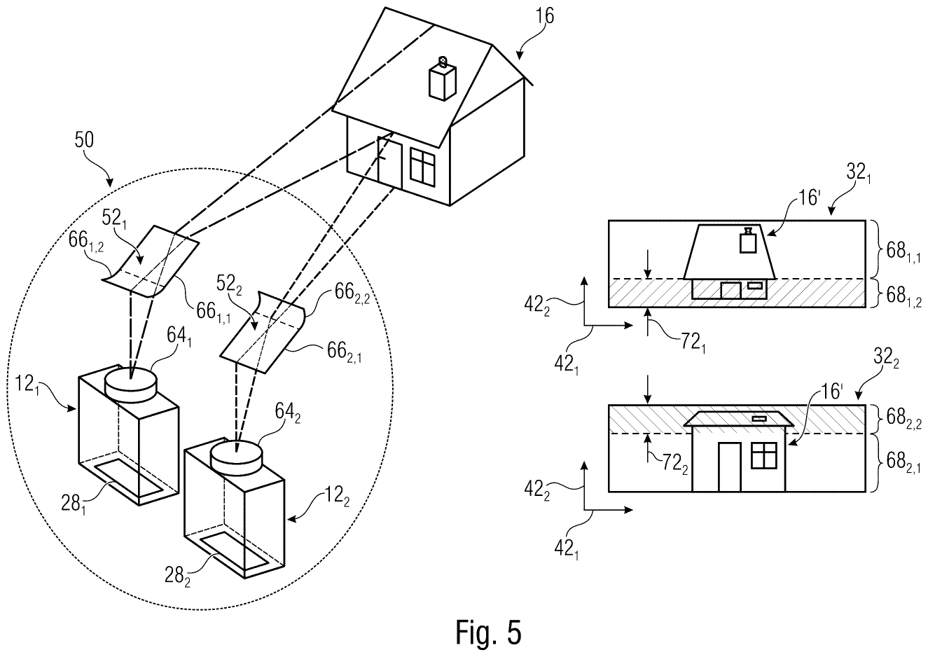

FIG. 5 shows a schematic perspective view of a multi-aperture device 50 according to an embodiment, in which optical channels 12₁ and 12₂ are arranged juxtaposed. Each optical channel 12₁ and 12₂ has an image sensor or image sensor area of an image sensor arrangement 28₁ and 28₂. The optics of the optical channels are not shown, but apertures 64₁ and 64₂ are shown in order to limit the field of view of the optical channels 12₁ and 12₂.

The optical channel 12₁ includes a beam-deflecting element 52₁ and the optical channel 12₂ includes a beam-deflecting element 52₂ to deflect a beam path towards the field of view 16.

In contrast to what is described in connection with FIG. 4, the beam-deflecting elements 52₁ and 52₂ are exemplarily configured in such a way that the local change in magnification takes place along only one of the image directions 42₁ and 42₂, exemplarily the image direction 42₂. Thus, each of the beam-deflecting elements 52₁ and 52₂ may include independently of the respective other beam-deflecting element, but also implemented in an analogue or complementary manner two areas 66_{1,1} and 66_{1,2} or 66_{2,1} and 66_{2,2} configured differently from one another. The areas 66_{1,1} and 66_{2,1} may, for example, provide an essentially planar area of the beam-deflecting surface of the beam-deflecting element 52₁ or 52₂. The essentially planar area may be arranged for a first magnification of a partial field of view of the field of view detected based on the planar area. Curved areas 66_{1,2} or 66_{2,2} arranged adjacent thereto may be arranged for a comparatively lower second magnification of a partial field of view of the field of view 16 detected based on the curved area. This is depicted exemplarily using the image 32₁ captured with the first optical channel 12₁ and the image 32₂ captured with the second optical channel 12₂. Image contents of the field of view 16 are displayed as image 16′ in images 32₁ and 32₂.

Based on the arrangement of the curved areas 66_{1,2} and 66_{2,2}, for example, a lower area of the displayed house of the field of view 16 can be displayed compressed in the optical channel 12₁, as shown, for example, using an image area 68_{1,2} of the image 32₁. In addition to this, based on the curved area 66_{2,2}, another and possibly disjoint or at least at most partially overlapping area of the field of view 16 can be shown compressed in the optical channel 12₂, as is shown, for example, using the partial area 68_{2,2} of the image 32₂. Areas 68_{1,1} and 68_{2,1} in the images 32₁ and 32₂, which are captured with the less curved areas 66_{1,1} and 66_{2,1}, for example configured as plane mirrors, may have a higher resolution or a higher magnification.

In such an embodiment, it is conceivable that, based on the varying magnification of the optical channels, a first image 32₁ of the field of view 16 obtained with the first optical channel 12₁ has a first magnification for a first partial area 68_{1,1} of the field of view and a comparatively lower second magnification for a second partial area 68_{1,2} of the field of view. Based on the varying magnification, a second image 32₂ of the field of view 16 obtained with the second optical channel 12₂ has a third magnification for a third partial area 68_{2,1} of the field of view 16 and a comparatively lower fourth magnification for a fourth partial area 68_{2,2} of the field of view 16. In an embodiment in which the curvatures of the curved parts 66_{1,1} and 66_{2,2} are the same, the second magnification and the fourth magnification may have the same values. It is also conceivable to obtain matching magnification values for the first magnification and the third magnification if the planarity or curvature of the areas 66_{1,1} and 66_{2,1} match. Advantageously, the first partial area 68_{1,1} and the fourth partial area 68_{2,2} overlap at least partially and/or the second partial area 68_{1,2} and the third partial area 68_{2,1} overlap at least partially. In other words, a compression 72₁ and 72₂ takes place in the optical channels 12₁ and 12₂ at least partially in different areas of the field of view 16.

According to an embodiment, the beam-deflecting surface of the beam-deflecting element 52₁ and/or the beam-deflecting surface of the beam-deflecting element 52₂ include a local convex area, which means that the beam-deflecting surface is formed convex there at least in some areas and is formed deviating from this in other areas or having at least a different curvature value. For example, and with reference to FIG. 5, a curvature may only occur in a certain area, while in other areas there is a planar configuration, wherein different curvatures, see for example FIG. 4, are also conceivable. A compression 72 obtained with the convex area is localised in different channels in at least partially corresponding areas of the total field of view. It is therefore possible to deviate from the configuration shown in FIG. 5. Alternatively, the first beam-deflecting surface and/or the second beam-deflecting surface may have a local concave area, wherein a compression obtained with the concave area is localised in different channels in at least partially corresponding areas of the field of view 16.

In some embodiments, a variation of the compression depends directly or indirectly on the increase or decrease of the curvature, which can be described as the reciprocal of the radius of curvature, which may be implemented in any direction in both the convex and the concave case. In the context of embodiments discussed herein, a centre of curvature on the side of the projection centre of the objective may be associated with a negative curvature value as concave and on the side facing away from it with a positive curvature value as convex. Accordingly, the compression may increase along the direction in which a concave mirror increases in concavity and a convex mirror decreases in convexity. So if the compression is to be lowest where the optical axis of the objective penetrates the mirror surface, it is advantageous to increase the amount of curvature away from the penetration point in the convex case and towards the penetration point in the concave case.

The curvature and the change in curvature may be defined as a signed variable, i.e. a changing negative curvature or a changing positive curvature, but also as an absolute value. Perhaps the simplest use case is a curvature with the same tendency to increase or decrease in both channels, i.e. either two convex or two concave mirrors. This allows the use of two identical or similar objectives in the channels. With regard to the signed curvature, this means that it increases from the optical axis, regardless of whether it is convex or concave. In contrast, the absolute value of the curvature away from the optical axis increases with a convex mirror and decreases with a concave mirror. In other words, the curvature changes can be understood as signed values or as absolute values.

The representation of the compression 72₁ and 72₂, for example along a first image direction 42₂, which may be arranged vertically in three-dimensional space, is to be understood arbitrarily and not restrictively. The compression 72₁ and/or 72₂ may also be arranged along a different image direction 42₁ or, for example, as a straight or curved extension, similar to a diagonal along several image directions.

In other words, FIG. 5 shows a schematic three-dimensional representation of the cameras for channel 12₁ and channel 12₂ with their apertures 64₁ and 64₂ respectively, as well as the composite mirrors 52₁ and 52₂ with which a scene 16 is viewed. The planar parts 66_{1,1} and 66_{2,1} of the mirrors are slightly inclined towards each other, so that the upper half of the scene is observed by the planar mirror in channel 12₁ and the lower half by the planar mirror in channel 12₂. The possibly cylindrically curved parts 66_{1,2} and 66_{2,2} may form a complementary vertically compressed image of the lower half of the scene 16 in channel 12₁ and the upper half in channel 12₂. The images 32₁ and 32₂ show that the entire scene is displayed once uncompressed and once compressed. This can also be transferred to other embodiments within a tolerance range of 10%, 5% or less, for example 2%, so that within the said tolerance range the field of view is captured once with a first magnification value and once with a second magnification value.

Also in this embodiment, the first locally varying magnification of the channel 12₁ is different with respect to the second locally varying magnification of the optical channel 12₂. Although only in one image direction, the optical channel 12₁ is also arranged in the embodiment of FIG. 5 to provide a first multiscale image of the field of view 16 and the optical channel 12₂ is arranged to provide a second multiscale image of the field of view 16.

With reference to the planar deflection elements 52 shown exemplarily in portions, it is pointed out that the magnification along one (image) direction caused by a partial area may optionally differ from the magnification along the direction perpendicular thereto. This may be equivalent to the fact that surface curvatures of the mirrors differ along these directions. In an extreme case, for example according to one of the cylindrical curvatures along the vertical direction of the surfaces 66_{1,2} and 66_{2,2}, the curvature may, for example, be essentially or almost 0 in a first direction and have a value significantly different from 0 in the other, possibly orthogonal, direction. However, it is also conceivable that these areas have a curvature curve along the first, e.g. horizontal, direction. This may nevertheless differ significantly from the curvature curve along the second, e.g. vertical, direction. This means that the concept of curvature is not to be understood as a purely scalar quantity. The curvature and also the magnification are each a two-dimensional quantity, as they may be different along two directions arranged perpendicular to each other, but do not have to be.

### Linking the Two Concepts

The deflecting mirrors of the camera arrays may be used as possible key elements for the realisation of continuously multiscale imaging and/or foveated imaging as well as the low-resolution redundancy of the total field of view. In this context, embodiments provide for superimposing the curvatures of the mirrors that can be used for both types of imaging. This can be understood to mean curvature curves of the beam-deflecting elements, for example. Such a superimposing does not necessarily have to be linear, although this is not excluded in the context of the embodiments. It is therefore not necessarily necessary to add local curvature values.

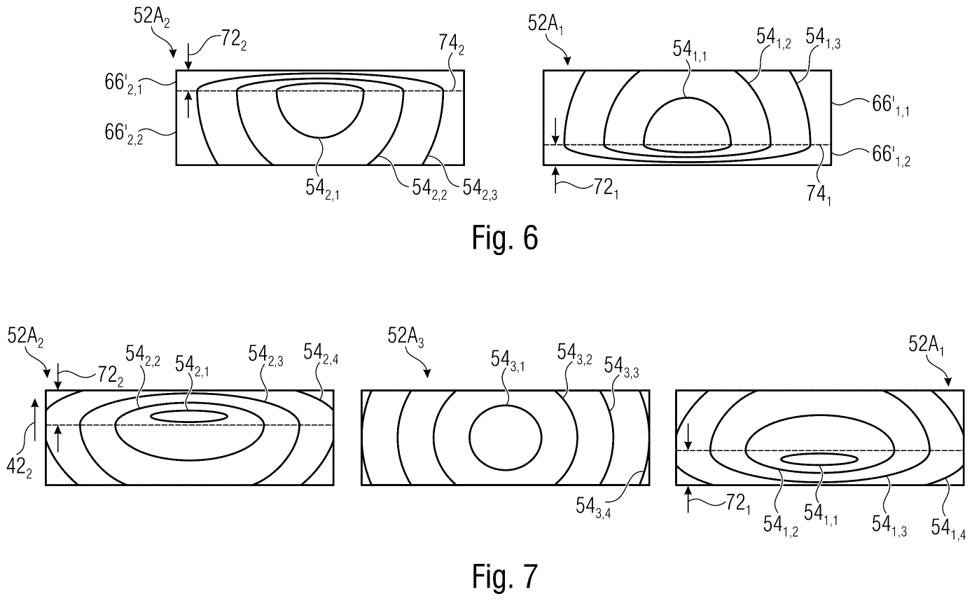

FIG. 6 shows a schematic front view of possible isolines 54 of the magnification on a sensor plane, for example of an image sensor, as can be obtained by configurations of the embodiments, for example but not necessarily by configurations of the beam-deflecting surfaces 52A₁ and 52A₂, such as can be used in the multi-aperture device 50. The isolines 54_{1,1} to 54_{1,3} and 54_{2,1} to 54_{2,3} show effects for the magnification, if, starting from the plane mirror configuration of the multi-aperture device 50, a curvature along two directions is provided in the elements 66_{1,1} and 66_{2,1} and/or an additional curvature is provided in the elements 66_{1,2} and 66_{2,2}.

It is recognisable that the isolines of the different images may be unequal to each other. In a configuration, the magnification curves of different optical channels may be related, for example in that the magnification curves as shown in FIG. 6 are unequal but nevertheless geometrically similar, for example in that an exemplary 180° rotation of one curve in relation to the field of view results in the distribution of another optical channel, as is also the case for the outer channels of FIG. 7. This does not rule out the possibility that one of the two channels also has an extension in the magnification curve, which can be visualised as an additional isoline.

In other words, FIG. 6 shows a representation of two sensor surfaces and isolines 54 of the magnification, which, as in FIG. 5, alternately see or depict the high-resolution areas of the respective other sensor or channel with low resolution. However, there is also a continuously multiscale image here. Areas in the centre with an inner isoline 54_{2,1} or 54_{1,1} may have a comparatively higher magnification, while areas at the edge with the outer isoline 54_{2,3} or 54_{1,3} have a lower resolution or vice versa, depending on the direction of curvature of the surface. A vertical compression 72₁ or 72₂ in the smaller areas separated by the lines 74₁ and 74₂ is depicted superimposed with the radial magnification curve by compressing the isolines there perpendicularly, which may result in changed areas 66′_{1,1}, 66′_{1,2}, 66′_{2,1} and 66′_{2,2} in reference to FIG. 5.

A multi-aperture device described herein may provide a first imaging effected with the optical channel 12₁, in which a magnification decreasing from a magnification maximum, for example shown in isolines 54_{1,1} and 54_{2,1}, occurs along one or two spatial directions. A second image effected with a second optical channel may have a decreasing magnification starting from a magnification maximum, for example shown at the isolines 54_{2,2}. This can be done irrespective of whether or not the area-based subdivision shown by the lines 74₁ and 74₂ is implemented.

A multi-aperture device described herein may alternatively or additionally be arranged for catadioptric imaging with the optical channel 12₁ and for catadioptric imaging with the channel 12₂.

FIG. 7 shows a schematic front view of parts of a multi-aperture device according to an embodiment, in which at least a third optical channel is provided. A higher number of optical channels is easily possible. In the implementation shown in FIG. 7, each area of a field of view not shown is captured by at least two optical channels. In the specific configuration of FIG. 7, the beam-deflecting surface 52A₃ may be formed differently from the beam-deflecting surfaces 72₁ and 72₂ along the image direction 42₂ with beam-deflecting surfaces 52A₁ and 52A₂, for example without compression or with isotropic compression, such as a radial compression, e.g. without anisotropic compression.

Otherwise than shown in FIG. 7, some embodiments provide that a third optical channel used is configured to provide at least one image of the field of view or a portion thereof at a substantially uniform magnification across the optical channel, which would result in the elimination of isolines 54_{3,1} to 54_{3,4}.

In a configuration variant, the third optical channel is arranged between the optical channels 12₁ and 12₂ in the arrangement of optical channels as shown in FIG. 7. However, this is not necessary, taking into account the occurrence of altered and possibly asymmetrical parallax effects, so that when three optical channels are arranged, the additional optical channel shown may also be arranged on the outside or may also be directed in a different direction with the aid of additional beam-deflecting means.

In other words, the field of view may be divided vertically into more than two channels and/or divided horizontally. A possible configuration is shown in FIG. 7, in which additional vertically compressed areas only occur in the two channels at the edge. However, any other distribution of parts of the total field of view is possible, wherein it is advantageous that each area of the total field of view is observed or imaged by at least two channels. An exception may be areas of a scene that are still visible due to parallaxes at the edge of a channel and are outside the edge of the field of view in the actually redundant channel.

In other words, FIG. 7 shows an illustration of a possible realisation of three optical channels, wherein only the outer two optical channels have additional vertically compressed areas of the total field of view. Indices j of the isolines 54i,j with the same designation, i.e. the same value for j, represent the same magnifications in the image of the different optical channels.

### Variability of Relative Positioning

In addition to the previously mentioned way of positioning of the various optical channels in relation to each other, other variants are easily possible.

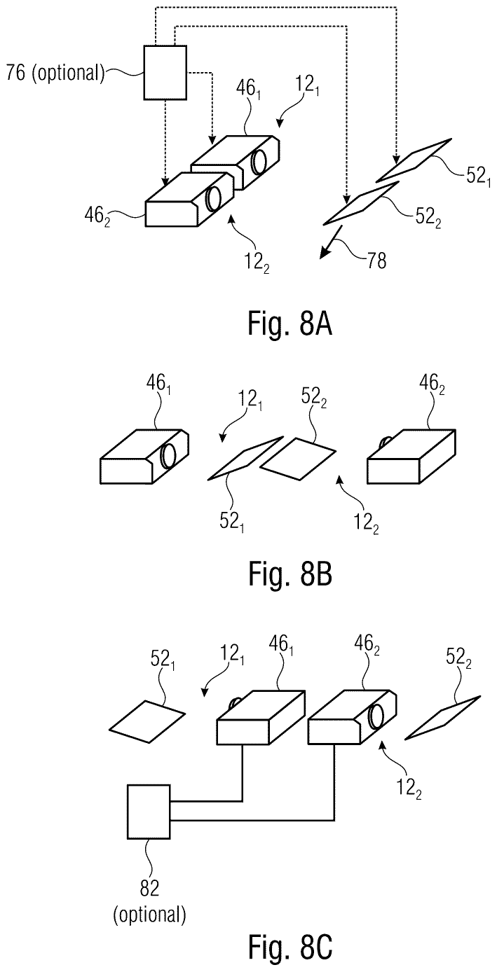

Exemplary configurations are described with reference to FIGS. 8A-8C. For example, FIG. 8A shows an illustration of optical channels 12₁ and 12₂, in which cameras 46₁ and 46₂, i.e. the optics and image sensors are arranged looking in the same direction and deflected by an optimum beam-deflecting element 52₁ and 52₂ respectively.

FIG. 8B shows an altered representation in which the cameras 46₁ and 46₂ are arranged looking to each other and the optical channels 12₁ and 12₂ have an antiparallel arrangement in an area between the cameras 46₁ and 46₂ respectively and the corresponding beam-deflecting element 52₁ and 52₂ respectively.

FIG. 8C shows an implementation inverse to FIG. 8B, in which the cameras 46₁ and 46₂ look away from each other.

In general, embodiments are not limited to a mono capture. Alternatively or additionally, at least a part of the field of view or the field of view may be captured by a second or a higher number of modules (multi-aperture devices) to form, for example, stereo, trio, quattro cameras or higher-quality cameras. The individual modules may be shifted by fractions of a pixel and may be configured to implement super-resolution processes. For example, a number of optical channels and/or a number of multi-aperture devices and/or a number of partial fields of view are arbitrary.

The variants shown in FIGS. 8A-8C may be combined as desired, for example in the form of four or more optical channels, wherein in the case of four optical channels, two may be placed juxtaposed, facing the other two channels. The distance between the mirrors or beam-deflecting means may also vary and may range from a minimum possible proximity to an artificial gap. Furthermore, in a possible configuration, the distance between the respective camera 46 and the beam-deflecting element 52 of a channel may also be variably manipulated by a movement device, for example to support focusing. In such a configuration, an actuator means is provided which is configured to adjust a focus of the multi-aperture device and/or to perform optical image stabilisation.

This is shown by way of example in FIG. 8A, in which actuator means 76 may be configured to adjust a focus of the multi-aperture device. For this purpose, for example, a relative position between the image sensor of one or more cameras 46₁ and 46₂ and the corresponding optics may be changed and/or a distance between the beam-deflecting elements 52₁ and/or 52₂ with respect to the associated optics and/or the image sensor.

Alternatively or additionally, the actuator means 76 may be configured to produce a translatory relative movement between the beam-deflecting elements 52₁ and/or 52₂ on the one hand and the optics and/or the image sensor of the cameras 46₁ or 46₂ on the other hand for optical image stabilisation. In a possible embodiment, which is also possibly easier to realise, the actuator means 76 may, for example, combine a translatory relative movement of one or more beam-deflecting elements 52₁ and 52₂ along a line extension direction 78, along which the optical channels are arranged, with a rotational movement of the beam-deflecting elements 52₁ and 52₂ for image stabilisation along two directions.

The actuator means 76 may readily be used in another multi-aperture device described herein.

FIG. 8C shows image processing means 82 which can be used there and also in other multi-aperture devices according to the disclosure described herein. This may be configured to receive image information from the optical channels 12₁ and 12₂ or the image sensor areas assigned to these optical channels. The image processing means 82 may be configured to combine the image information into an overall image. This is particularly advantageous if the multi-aperture device has an image sensor device that is arranged to image the field of view.

The image processing means 82 may be configured to provide one or more of the following functions, which may be preset, automatic, or static or variable based on user input:
a reconstruction of a two-dimensional representation of the field of view (16);
a calculation of a depth map for the entire image;
a calculation of a three-dimensional representation of the field of view (16);
a calculation of an HDR representation of the field of view (16),
a calculation of a multiscale video;
a calculation of a video of the field of view rectified to a constant magnification (16);
a simulation of a long exposure of the field of view (16).

A multi-aperture device described herein may be configured, for example using the image processing means 82, to utilise image information associated with the optical channels as reference image information for compositing. Corresponding points in the image information of one or more other channels may be determined in relation to the reference image information. The overall image may be created for at least a subset of corresponding points based on the image information that is best suited for this purpose or is selected on the basis of an optimisation criterion, for example by the image processing means 82. For example, the image information may be selected from a set of image information with corresponding points for which the image information is available with the highest quality or is available closer to the optimisation criterion. For example, a maximum magnification or a maximum resolution may be used. In a configuration, for example, it may be determined for each of these points from which image information the greatest resolution or the greatest magnification may be obtained and the image information from those channels may be selected in each case. This does not rule out using one of the optical channels as the primary channel, nor does it rule out to interpolate the different points of one or more image information, but at the same time it is not necessary.

According to a configuration, a multi-aperture device described herein is configured, for example using the image processing means 82, to calculate the overall image as a continuously rectified image with uniform magnification and a field of view dependent on the magnification.

In other words, FIGS. 8A-8C show a juxtaposed arrangement (FIG. 8A) and an opposite arrangement of the mirrors (FIG. 8B) or the cameras (FIG. 8C) of two channels as examples of different positioning of the components. For the sake of simplicity, the mirrors are shown here as planar; but in embodiments as described herein, they may be at least partially curved along at least one direction.

### Processing Options for the Individual Images

The following image processing methods may be carried out with the individual images of the multi-channel system: the reconstruction of 2D images, the calculation of depth maps, the reconstruction of 3D views of the scene in the form of point clouds, textured mesh grids and other common 3D data formats, the calculation of HDR images that go beyond the dynamic range of the image sensors and are calculated from several sequential image measurements of all channels, the composition of many sequential image measurements into a multiscale video or a video with fixed magnification from rectified images, the simulation of long exposure, which exceeds the maximum exposure time of the sensors and is calculated from several sequential images of all channels. All variants may also be based on data from an incomplete number of channels.

In order to be able to process the measured raw images of the channels with geometric precision, a calibration may be carried out that goes beyond the calibration of the individual channels with their objectives alone. This may be a single-stage or a two-stage process, for example.

In the two-stage process, the objectives of the channels without mirrors may first be calibrated individually in order to determine parameters such as focal lengths, main points and distortion coefficients in the pinhole camera model. There are established methods for this that measure a calibration object, e.g. a plane with a chessboard pattern, from different perspectives. In the second stage, the parameters of models have to be determined which adequately describe the beam-deflecting of the unevenly or asymmetrically shaped mirrors. The second step also includes the determination of the relative position of the channels to each other, which includes the determination of further extrinsic parameters, specifically three of the rotation, three of the translation and a scaling parameter between pairs of channels. In this second calibration step, a calibration object may be used in a similar way to the first calibration step, with the difference that the objectives and mirrors have already been assembled.

In contrast to this is a single-stage or holistic calibration approach, which combines the intrinsic parameters of the objectives, the parameters of the models for beam-deflecting of the mirrors and the extrinsic parameters of the channels in a single model.

As a further part of a calibration, which may be carried out additionally or at least partially as a substitute, it is conceivable to calibrate each optical channel completely, i.e. with multiscale imaging, in a single step and then calibrate only the relative positioning and orientation of the channels to each other in a further step.

In this parameter space, for example, an optimum is sought so that the point measurements of the channels consistently reconstruct the poses of the calibration object when projected back into the field of view. With holistic calibration in a single step, a previous two-stage calibration can be converted into an initial parametrisation of the entire system. Different variants, which have already been presented or will be presented in the following, may need different calibration strategies. For example, a degree of freedom of a channel in the form of the displacement of the camera to the mirror involves that this is taken into account in the calibration.

Variations of the Variant with Curved Mirrors

Compared to the variants with curved mirrors described herein, embodiments provide for modifications thereof which do not require curved mirrors, but do not exclude them either. A common feature of the embodiments is that a low-resolution and/or high-resolution redundancy of the total field of view is generated in the optical channels of the camera array. Secondly, the configurations compress the field of view in such a way that different magnifications can be reconstructed in high resolution.

The compression of the field of view may be achieved in different ways to those presented so far. For example, local curvatures of the mirrors may be used so that the compression of the overall field of view does not take place via the global curves already presented, but the channels continue to complement each other in terms of redundancy and multiscale imaging.

A further modification is to bring the compression of the total field of view partially or completely into the objectives of the channels instead of into the mirrors. In the complete case, this would have the advantage associated with plane mirrors that a displacement of the objective relative to the mirror, for example for focusing, does not necessarily have to be taken into account in a further degree of freedom of the calibration. A possible disadvantage would be that the objective itself may not be an established model, but may have to be customised. However, it may also be possible to realise image compression by attaching an attachment to the objective. In a further variation, there are no mirrors, but the channels only look out at a slight angle to each other from the side of the aperture which is penetrated by their optical axes. The relative inclination of the viewing directions to each other may be caused by prismatic lenses, for example.

The type of optical imaging envisaged by the present invention may be realised by optical elements such as spherical, aspherical and freeform lenses, cylindrical, spherical, parabolic, aspherical and freeform mirrors, metalenses, micromirror actuators (digital micromirror devices, DMDs) and spatial light modulators (SLMs). The light may be spectrally and/or polarisation-dependent filtered and/or the pixels of the sensors may individually and/or together have a spectrally dependent and/or polarisation-dependent sensitivity. Different variants of CCD and CMOS sensors may be used, in particular event-based sensors.

### Another Method for Assembling the Images

In contrast to the aforementioned possibilities for combining the image information, embodiments provide for further possibilities that may be combined with each other, may be used individually, but may also be optional.

To assemble the images of the individual optical channels without parallax artefacts, one channel is defined as a so-called primary channel in one possible configuration of the embodiments described herein. This images the entire maximum image field to be realised. Its so called raw image, i.e. the image provided by the sensor with possibly locally different magnification, is normalised in a first step, i.e. transferred in a conventional raster image (with sub pixel precision) with homogeneous, i.e. normalised, magnification. The a priori known intrinsic calibration, especially the so-called de-destortion function, is mainly used for this purpose. Normalisation is also applied to the secondary optical channels. In addition, each pixel in the respective normalised image is assigned a weight that represents its original optical magnification.

In the second step, a plurality of corresponding points in the respective normalised images is determined using suitable methods, for example using the extrinsic calibration known a priori, in particular the relative orientations of the individual secondary optical channels in relation to the primary. From this, dense correspondence maps (with sub pixel precision) are derived, which describe which pixel in the respective secondary channel corresponds to the pixel of the primary channel.

In the third step, for example, corresponding pixels are searched for in all secondary channels for each pixel of the primary channel. The channel that has the greatest weight, which equates to the highest optical magnification, is selected. The pixel is interpolated from this channel into the output image. In object configurations in which, for example, no corresponding pixels can be found at object edges due to parallax errors, the (possibly lower-resolution) image information can be used from the authoritative primary channel. This avoids the typical image errors, as the human eye reacts much less sensitively to selectively reduced spatial resolution than to image errors.

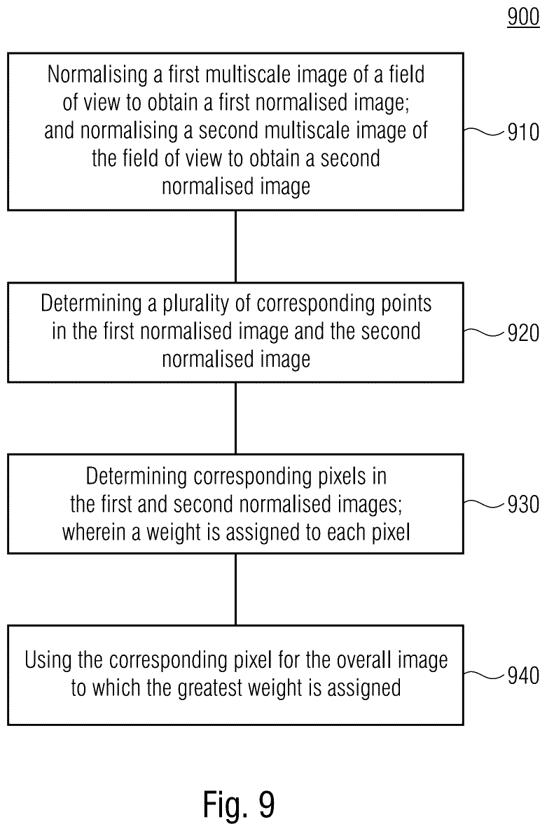

FIG. 9 shows a schematic flow diagram of a method 900 according to an embodiment, by means of which an overall image can be generated. A step 910 includes normalising a first multiscale image of a field of view to obtain a first normalised image. Furthermore, a second multiscale image of the field of view is normalised to obtain a second normalised image. For example, images of multi-aperture devices described herein may be normalised. In a step 920, a plurality of corresponding points are determined in the first normalised image and in the second normalised image.

In a step 930, corresponding pixels in the first and second normalised images are determined, each pixel being assigned a weight. In a step 940, the one of the corresponding pixels to which the greatest weight is assigned is used for the overall image. The weight may, for example, be associated with or correspond to the quality, resolution or magnification.

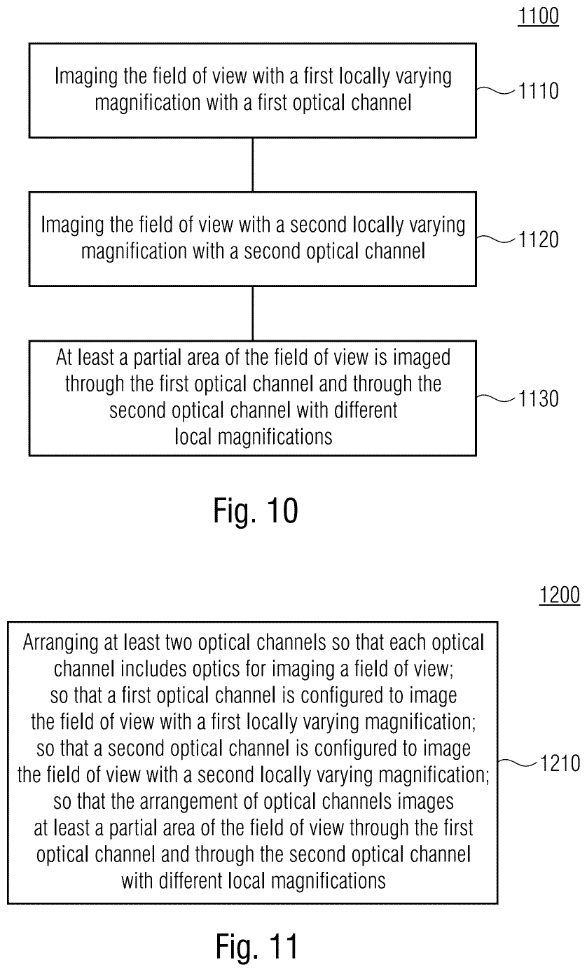

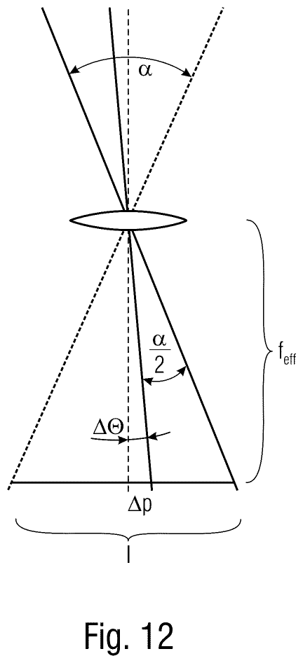

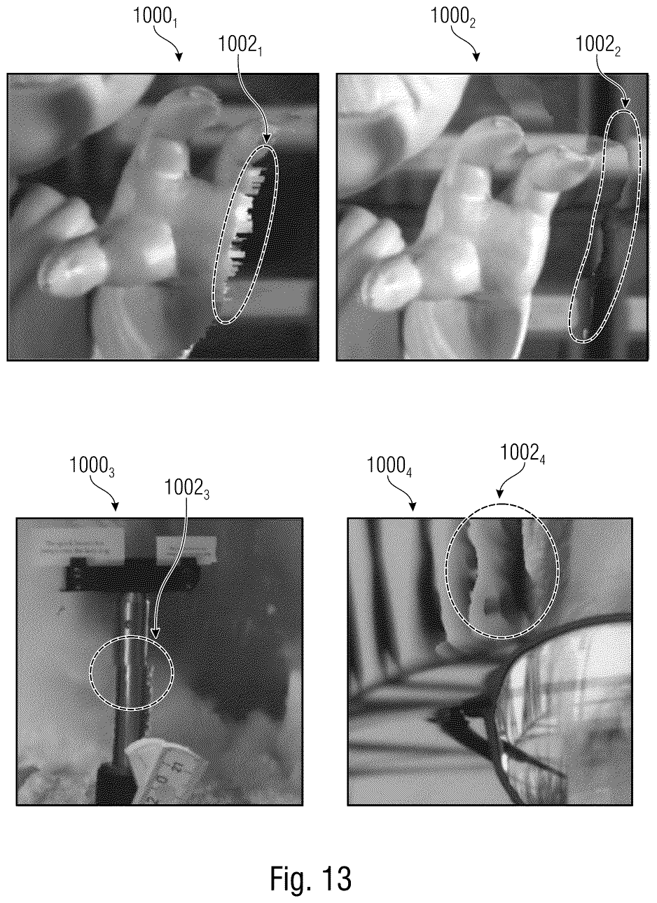

FIG. 10 shows a schematic flow diagram of a method 1100 according to an embodiment, which can be used, for example, to detect a field of view. In a step 1110, the field of view is imaged with a first locally varying magnification with a first optical channel. In a step 1120, the field of view is imaged with a second locally varying magnification with a second optical channel. The method is provided in a configuration 1130 in which at least a partial area of the field of view is imaged through the first optical channel and through the second optical channel with different local magnifications.

FIG. 11 shows a schematic flow diagram of a method 1200 for providing a multi-aperture device, such as but not necessarily described herein.

In a step 1210, at least two optical channels are arranged so that each optical channel includes optics for imaging a field of view. A first optical channel is configured to image the field of view with a first locally varying magnification and a second optical channel is configured to image the field of view with a second locally varying magnification. The method is implemented in such a way that the arrangement of optical channels images at least a partial area of the field of view through the first optical channel and through the second optical channel with different local magnifications.

Some of the embodiments described herein utilise the effect of foveated imaging or foveated arrays in such a way that the fixed coupling of image size, sensor size, field of view and resolution is eliminated in a camera system. Instead, the resolution for certain image areas may be reduced in favour of a smaller image size without having to reduce the field of view. This has advantages in the multi-channel camera systems described here as well as in other systems.

One of the main advantages of the foveated array according to embodiments is that high-performance optics, for example for smartphones, may be realised in a much more compact design, while at the same time only a comparatively small amount of additional effort is needed to offer or provide several optical focal lengths. Specifically, for example, an optical assembly in a smartphone with the typical three focal lengths of wide-angle, normal focal length and telephoto objective may be realised with comparative performance at half the height and with two optical channels of the foveated array described. This is possible because areas on the image sensors with comparable optical resolution can be utilised more efficiently.

A further advantage of the embodiments described herein is the minimisation of typical artefacts when combining the various optical channels, for example at object edges.

Embodiments of the present invention may be used for extremely compact implementation of high-quality imaging solutions that utilise larger image sensors for larger pixel counts and/or larger pixel sizes for higher sensitivity, e.g. in smartphones or other applications where height is limited.

Although some aspects have been described in connection with an apparatus, it is understood that these aspects also constitute a description of the corresponding method, so that a block or component of an apparatus is also to be understood as a corresponding method step or as a feature of a method step. Similarly, aspects described in connection with or as a method step also constitute a description of a corresponding block or detail or feature of a corresponding device.

Depending on specific implementation requirements, embodiments of the invention may be implemented in hardware or in software. The implementation may be carried out using a digital storage medium, for example a floppy disc, a DVD, a Blu-ray Disc, a CD, a ROM, a PROM, an EPROM, an EEPROM or a FLASH memory, a hard disk or another magnetic or optical memory, on which electronically readable control signals are stored, which can or do interact with a programmable computer system in such a way that the respective method is carried out. The digital storage medium may therefore be computer-readable. Thus, some embodiments according to the invention include a data carrier having electronically readable control signals capable of interacting with a programmable computer system such that one of the methods described herein is carried out.

In general, embodiments of the present invention may be implemented as a computer program product which includes a program code, wherein the program code is operative to perform one of the methods when the computer program product is running on a computer. The program code may also be stored on a machine-readable medium, for example.

Other embodiments include the computer program for performing any of the methods described herein, wherein the computer program is stored on a machine-readable medium.

In other words, an embodiment of the method according to the invention is thus a computer program which comprises a program code for performing one of the methods described herein when the computer program is running on a computer. A further embodiment of the methods according to the invention is thus a data carrier (or a digital storage medium or a computer-readable medium) on which the computer program for carrying out one of the methods described herein is recorded.

Thus, a further embodiment of the method according to the invention is a data stream or a sequence of signals representing the computer program for carrying out one of the methods described herein. The data stream or the sequence of signals may, for example, be configured to be transferred via a data communication link, for example via the Internet.

A further embodiment includes a processing device, such as a computer or programmable logic device, configured or adapted to carry out any of the methods described herein.

Another embodiment includes a computer on which the computer program for carrying out one of the methods described herein is installed.

In some embodiments, a programmable logic device (for example, a field programmable gate array, a FPGA) may be used to perform some or all of the functionalities of the methods described herein. In some embodiments, a field programmable gate array may interact with a microprocessor to carry out any of the methods described herein. In general, in some embodiments, the methods are carried out by any hardware device. This can be universally applicable hardware such as a computer processor (CPU) or hardware specific to the process, such as an ASIC.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] S. Baker and T. Kanade, “Limits on super-resolution and how to break them,” in IEEE Transactions on Pattern Analysis and Machine Intelligence, vol. 24, no. 9, pp. 1167-1183 September 2002
[2] Oberdörster, Alexander, and Hendrik P. A. Lensch. “Resolution and Sensitivity of Wafer-Level Multi-Aperture Cameras,” Journal of electronic imaging, vol. 22, no. 1, 2013
[3] A. Oberdörster, P. Favaro and H. P. A. Lensch, “Anamorphic pixels for multi-channel superresolu-tion,” 2014 IEEE International Conference on Computational Photography (ICCP), Santa Clara, CA, USA, 2014, pp. 1-10
[4] A. Brückner, J. Duparré, R. Leitel, P. Dannberg, A. Bräuer and A. Tünnermann, “Thin wafer-level camera lenses inspired by insect compound eyes,” Opt. Express 18, 24379-24394 (2010)
[5] A. Oberdörster, A. Brückner and F. Wippermann, “Folded multi-aperture camera system for thin mobile devices,” SPIE Proceedings Volume 10545, MOEMS and Miniaturized Systems XVII, 2018

1. Multi-aperture device, comprising:
an arrangement of at least two optical channels, wherein each optical channel comprises optics for imaging a field of view;
wherein a first optical channel is configured to image the field of view with a first locally varying magnification;
wherein a second optical channel is configured to image the field of view with a second locally varying magnification;
wherein the arrangement of optical channels is configured to image at least a partial area of the field of view through the first optical channel and through the second optical channel with mutually different local magnifications.

2. The multi-aperture device according to claim 1, wherein the first optical channel is arranged to provide a first multiscale image of the field of view and the second optical channel is arranged to provide a second multiscale image of the field of view.

3. The multi-aperture device according to claim 1, in which the first locally varying magnification is unequal to the second locally varying magnification in at least a partial area of the field of view.

4. The multi-aperture device according to claim 1, wherein a first image effected with the first optical channel comprises a decreasing magnification starting from a magnification maximum; and a second image effected with the second optical channel comprises a decreasing magnification starting from a magnification maximum.

5. The multi-aperture device according to claim 1, which is arranged for catadioptric imaging with the first optical channel; and for catadioptric imaging with the second optical channel.

6. The multi-aperture device according to claim 1, wherein the first optical channel comprises a first beam-deflecting element with a first beam-deflecting surface for deflecting a first beam path of the first optical channel; wherein the first beam-deflecting surface comprises a first surface curvature to at least partially effect the first locally varying magnification; and/or
wherein the second optical channel comprises a second beam-deflecting element with a second beam-deflecting surface for deflecting a second beam path of the second optical channel; wherein the second beam-deflecting surface comprises a second surface curvature to at least partially effect the second locally varying magnification.

7. The multi-aperture device according to claim 6, wherein the first surface curvature comprises an increasing curvature starting from an optical axis of the first optical channel; and/or wherein the second surface curvature comprises an increasing curvature starting from an optical axis of the second optical channel; or
wherein the first surface curvature comprises a decreasing curvature starting from an optical axis of the first optical channel; and/or wherein the second surface curvature comprises a decreasing curvature starting from an optical axis of the second optical channel.

8. The multi-aperture device according to claim 6, wherein the first and second beam-deflecting surfaces comprise a substantially planar area, which is arranged for a first magnification of a partial field of view of the field of vie detected based on the planar area, and which comprises a curved area arranged adjacent to the planar are, which is arranged for a lower second magnification of a partial field of view of the field of view detected based on the curved area.

9. The multi-aperture device according to claim 8, wherein, based on the varying magnification, a first image of the field of view acquired with the first optical channel comprises a first magnification for a first partial area of the field of view and a comparatively lower second magnification for a second partial area of the field of view; and
wherein, based on the varying magnification, a second image of the field of view acquired with the second optical channel comprises a third magnification for a third partial area of the field of view and a comparatively lower fourth magnification for a fourth partial area of the field of view;
wherein the first partial area and the fourth partial area at least partially overlap and/or wherein the second partial area and the third partial area at least partially overlap.

10. The multi-aperture device according to claim 6, wherein the first beam-deflecting surface and/or the second beam-deflecting surface comprise a local convex area, wherein a compression acquired with the convex area is localised in different channels at at least partially coinciding areas of the field of view; or
wherein the first beam-deflecting surface and/or the second beam-deflecting surface comprise a local concave area, wherein a compression acquired with the concave area is localised in different channels at at least partially corresponding areas of the field of view.

11. The multi-aperture device according to claim 6, wherein the first surface curvature extends along two orthogonal directions; and/or the second surface curvature extends along two orthogonal directions.

12. The multi-aperture device according to claim 11, which is configured to magnify areas at the edge of the field of view in the first optical channel and in the second optical channel to a lesser extent than areas in a centre of the field of view.

13. The multi-aperture device according to claim 6 with an actuator for adjusting a focus of the multi-aperture device; and/or for performing optical image stabilisation.

14. The multi-aperture device according to claim 1, in which first optics of the first optical channel is configured to at least partially effect the locally varying magnification; and/or
wherein second optics of the second optical channel is configured to at least partially effect the locally varying magnification.

15. The multi-aperture device according to claim 1, in which the first locally varying magnification is formed continuously variable along at least one image direction of the first optical channel; and/or
wherein the second locally varying magnification is formed continuously variable along at least one image direction of the second optical channel.

16. The multi-aperture device according to claim 1, wherein the arrangement comprises at least a third optical channel, wherein each area of the field of view is detected by at least two optical channels.

17. The multi-aperture device according to claim 16, wherein the third optical channel is configured to provide at least one image comprising a substantially uniform magnification across the optical channel.

18. The multi-aperture device according to claim 16, wherein the third optical channel is arranged between the first optical channel and the second optical channel in the arrangement.

19. The multi-aperture device according to claim 1, comprising an image sensor, wherein each optical channel is arranged to image the field of view onto an image sensor area of the image sensor.

20. The multi-aperture device according to claim 19 with an image processor, which is configured to acquire first image information from a first image sensor area associated with the first optical channel; and to acquire second image information from a second image sensor area associated with the second optical channel and to combine the first image information and the second image information into an overall image.

21. The multi-aperture device according to claim 20, in which the image processor is configured to effect at least one of:
a reconstruction of a two-dimensional representation of the field of view;
a calculation of a depth map for the entire image;
a calculation of a three-dimensional representation of the field of view;
a calculation of a HDR representation of the field of view,
a calculation of a multiscale video;
a calculation of a video of the field of view rectified to a constant magnification;
a simulation of a long exposure of the field of view.

22. The multi-aperture device according to claim 20, which is configured to utilise image information associated with one of the optical channels as reference image information, and to determine corresponding points in image information of at least one other channel with respect to the reference image information; and to create the overall image for at least a subset of corresponding points based on that image information which provides the image information with the greatest magnification or resolution for the corresponding point, e.g. by interpolation.

23. The multi-aperture device according to claim 20, wherein the image processor is configured to calculate the overall image as a continuously rectified image with uniform magnification and a field of view dependent on the magnification.

24. A method for generating an overall image, comprising:
normalising a first multiscale image of a field of view to acquire a first normalised image; and normalising a second multiscale image of the field of view to acquire a second normalised image;
determining a plurality of corresponding points in the first normalised image and the second normalised image;
determining corresponding pixels in the first and second normalised images; wherein a weight is assigned to each pixel;
using the corresponding pixel for the overall image to which the greatest weight is assigned.

25. A method for detecting a field of view, comprising:
imaging the field of view with a first locally varying magnification with a first optical channel;
imaging the field of view with a second locally varying magnification with a second optical channel;
so that at least a partial area of the field of view is imaged through the first optical channel and through the second optical channel with different local magnifications.
